(19) United States
(12) Patent Application Publication
(10) Pub. No.: US 2022/0372938 A1
(43) Pub. Date: Nov. 24, 2022

(54) EGR VALVE DEVICE

(71) Applicant: AISAN KOGYO KABUSHIKI KAISHA, Obu-shi, Aichi-ken (JP)

(72) Inventor: Koichi SUGIHARA, Chiryu-shi (JP)

(73) Assignee: AISAN KOGYO KABUSHIKI KAISHA, Obu-shi, Aichi-ken (JP)

(21) Appl. No.: 17/766,048

(22) PCT Filed: Sep. 24, 2020
(86) PCT No.: PCT/JP2020/035889

§ 371 Date: Apr. 1, 2022

(30) Foreign Application Priority Data
Oct. 25, 2019 (JP) 2019-194104

(51) Int. Cl. F02M 26/67; F02M 26/72; F02M 26/74

(52) U.S. Cl. CPC F02M 26/67; F02M 26/72; F02M 26/74

(57) ABSTRACT

An EGR valve device equipped with: a housing which contains a flow passage; a valve element for opening and closing the flow passage; a valve shaft to which the valve element is provided; and a mating member which includes an assembly hole in which the housing is assembled, and also includes another flow passage. The flow passage is connected to the other flow passage while the housing is assembled in the assembly hole of the mating member, and a sealing member is provided in at least one location between the outer surface of the housing and the inner surface of the assembly hole. The sealing member includes a vibration-reducing part which has a vibration-reducing function and is formed from an elastic material, and also includes a sealing part which has a sealing function.

### TECHNICAL FIELD

The present disclosure relates to an EGR valve device provided in an EGR passage and used to regulate a flow rate of EGR gas.

### BACKGROUND ART

Conventionally, as a technique of the above type, for example, an EGR valve described in Patent Document 1 listed below is known. This EGR valve is provided with a housing internally including a flow passage for EGR gas, a valve seat provided in the flow passage, a valve element provided to be capable of seating on the valve seat, and a valve shaft placed in the housing so as to extend through the flow passage and provided with the valve element. The flow passage includes a bent part bending from a direction coaxial with the valve shaft to a direction intersecting the valve shaft. The housing has a cylindrical shape, which is provided with an inlet at one end in the axial direction and an outlet at the outer periphery of the housing. This EGR valve is installed in the EGR passage so that the housing is assembled in the assembly hole provided in the EGR passage which is a mating member. Herein, a sealing structure is provided between the outer surface of the housing and the inner surface of the assembly hole to seal between them. This sealing structure includes two sealing members placed at two positions on the outer surfaces of the housing on both sides across the outlet of the flow passage.

### RELATED ART DOCUMENTS

### Patent Documents

Patent Document 1: Japanese unexamined patent application publication No. 2015-17506

### SUMMARY OF INVENTION

### Problems to be Solved by the Invention

Meanwhile, as the sealing members of the EGR valve described in Patent Document 1, an O-ring made of an elastic material, such as rubber, may be used. Herein, this O-ring usually has a circular cross-section taken along in an axial direction. In this case, when the O-ring is compressed between the outer surface of the housing and the inner surface of the assembly hole, the O-ring performs both the vibration-reducing function and the sealing function. Accordingly, the elastic reaction force (the vibration-reducing force and the sealing force) generated by compression of the O-ring tends to increase, thus applying stress to the housing. If the housing has a thin wall or made of a low-strength material, such as resin, the housing may be damaged by the stress.

The present disclosure has been made to address the above problems and has a purpose to provide an EGR valve device capable of reducing the stress caused by the elastic reaction force of a sealing member provided between a housing and a mating member.

### Means of Solving the Problems

(1) To achieve the mentioned purpose, one aspect of the present disclosure provides an EGR valve device comprising: a housing including a flow passage for EGR gas, the flow passage including an inlet and an outlet provided in the housing; a valve element to open and close the flow passage; a valve shaft to which the valve element is provided; and a mating member in which the housing is assembled, the mating member including: an assembly hole for the housing; and another flow passage, wherein when the housing is assembled in the assembly hole of the mating member, the inlet and the outlet of the flow passage communicate with the other flow passage, and a sealing member is provided in at least one place between an outer surface of the housing and an inner surface of the assembly hole, and wherein the sealing member is made of an elastic material and includes a vibration-reducing part having a vibration-reducing function and a sealing part having a sealing function.

According to the foregoing configuration (1), the sealing member provided between the outer surface of the housing and the inner surface of the assembly hole includes the vibration-reducing part having the vibration-reducing function and the sealing part having the sealing function. Thus, the vibration-reducing part and the sealing part of the sealing member separately contact the inner surface of the assembly hole.

(2) To achieve the above purpose, in the foregoing configuration (1), preferably, the sealing member is attached in advance in the at least one place on the outer surface of the housing.

According to the foregoing configuration (2), in addition to the operations of the configuration (1), when the housing is assembled in the assembly hole, the sealing member is simultaneously placed between the outer surface of the housing and the inner surface of the assembly hole.

(3) To achieve the above purpose, in the foregoing configuration (1) or (2), preferably, the sealing member is made of an elastic material in an annular shape.

According to the foregoing configuration (3), in addition to the operations of the configuration (1) or (2), the sealing member is made of an elastic material in an annular shape and thus can be easily molded.

(4) To achieve the above purpose, in the foregoing configuration (3), preferably, the sealing member is provided with a metal member for reinforcement, the metal member being placed inside the elastic material in the annular shape.

According to the foregoing configuration (4), in addition to the operations of the configuration (3), the shape and characteristics of the sealing member made of an elastic material are reinforced by the metal member.

(5) To achieve the above purpose, in any one of the foregoing configurations (1) to (4), preferably, the sealing member is configured such that the vibration-reducing part and the sealing part are formed separately and arranged adjacent to each other.

According to the foregoing configuration (5), in addition to the operations of one of the configurations (1) to (4), the vibration-reducing part and the sealing part are formed separately.

(6) To achieve the above purpose, in any one of the foregoing configurations (1) to (5), preferably, the sealing member is configured such that the vibration-reducing part and the sealing part are formed integral with each other.

According to the foregoing configuration (6), in addition to the operations of one of the configurations (1) to (5), the vibration-reducing part and the sealing part are integral with each other, which makes it easy to handle the sealing member.

(7) To achieve the above purpose, in any one of the foregoing configurations (1) to (6), preferably, the sealing member is configured such that the vibration-reducing part is placed in a posture to perform the vibration-reducing function and the sealing part is placed in a posture to perform the sealing function when the housing is assembled in the assembly hole.

According to the foregoing configuration (7), in addition to the operations of one of the configurations (1) to (6), simply assembling the housing in the assembly hole enables the vibration-reducing part and the sealing part of the sealing member to be placed in the postures for performing respective functions.

### Effects of the Invention

According to the configuration (1), it is possible to reduce the stress caused by the elastic reaction force of the sealing member provided between the housing and the mating member, thus preventing damage to the housing or the mating member due to the stress.

According to the foregoing configuration (2), in addition to the effects of the configuration (1), the sealing member can be used in the same manner as a conventional sealing member.

According to the foregoing configuration (3), in addition to the effects of the configuration (1) or (2), the sealing member can be produced in the same method as a conventional sealing member.

According to the foregoing configuration (4), in addition to the effects of the configuration (3), it is possible to improve the retaining force of the sealing member to the housing.

According to the foregoing configuration (5), in addition to the effects of one of the configurations (1) to (4), the degree of freedom for molding the vibration-reducing part and the sealing part can be increased.

According to the foregoing configuration (6), in addition to the effects of one of the configurations (1) to (5), the sealing member can be used in the same manner as the conventional sealing member.

According to the foregoing configuration (7), in addition to the effects of one of the configurations (1) to (6), it is possible to prevent the sealing member from curling up when the housing is assembled into the assembly hole and also ensure the vibration-reducing function and the sealing function of the sealing member.

### BRIEF DESCRIPTION OF THE DRAWINGS

FIG. 1 is a front view of an EGR valve device including a partial cross-sectional view in a first embodiment;

FIG. 2 is an exploded front view of the EGR valve device including a partial cross-sectional view in the first embodiment;

FIG. 3 is a front view of a housing to which a first sealing member and a second sealing member are attached in the first embodiment;

FIG. 4 is a front cross-sectional view of the housing to which the first sealing member and the second sealing member are attached in the first embodiment;

FIG. 5 is an enlarged cross-sectional view showing a part enclosed by a dot-dashed circle in FIG. 4 in the first embodiment;

FIG. 6 is an enlarged cross-sectional view showing a part enclosed by a dot-dashed circle in FIG. 1 in the first embodiment;

FIG. 7 is a front view of a housing in a second embodiment, corresponding to FIG. 3;

FIG. 8 is a front cross-sectional view of the housing in the second embodiment, corresponding to FIG. 4;

FIG. 9 is an enlarged cross-sectional view showing a part enclosed by a dot-dashed circle in FIG. 8 in the second embodiment;

FIG. 10 is an enlarged cross-sectional view showing a part of an EGR valve device in the second embodiment, corresponding to FIG. 6;

FIG. 11 is a front view of a housing in a third embodiment, corresponding to FIG. 3;

FIG. 12 is a front cross-sectional view of the housing in the third embodiment, corresponding to FIG. 4;

FIG. 13 is an enlarged cross-sectional view showing a part enclosed by a dot-dashed circle in FIG. 12 in the third embodiment;

FIG. 14 is an enlarged cross-sectional view showing a part of an EGR valve device in the third embodiment, corresponding to FIG. 6;

FIG. 15 is a front view of a housing in a fourth embodiment, corresponding to FIG. 3;

FIG. 16 is a front cross-sectional view of the housing in the fourth embodiment, corresponding to FIG. 4;

FIG. 17 is an enlarged cross-sectional view showing a part enclosed by a dot-dashed circle in FIG. 16 in the fourth embodiment;

FIG. 18 is an enlarged cross-sectional view showing a part of an EGR valve device in the fourth embodiment, corresponding to FIG. 6;

FIG. 19 is a front view of a housing in a fifth embodiment, corresponding to FIG. 3;

FIG. 20 is a front cross-sectional view of the housing in the fifth embodiment, corresponding to FIG. 4;

FIG. 21 is an enlarged cross-sectional view showing a part enclosed by a dot-dashed circle in FIG. 20 in the fifth embodiment;

FIG. 22 is an enlarged cross-sectional view showing a part of an EGR valve device in the fifth embodiment, corresponding to FIG. 6;

FIG. 23 is a cross-sectional view showing a sealing member in a state before being assembled in a sixth embodiment;

FIG. 24 is a cross-sectional view showing one step in a process of assembling a housing attached with the sealing member into an assembly hole of a housing adaptor in the sixth embodiment;

FIG. 25 is a cross-sectional view showing one step in the process of assembling the housing attached with the sealing member into the assembly hole of the housing adaptor in the sixth embodiment;

FIG. 26 is a cross-sectional view showing one step in the process of assembling the housing attached with the sealing member into the assembly hole of the housing adaptor in the sixth embodiment;

FIG. 27 is a cross-sectional view showing the sealing member in a state after being assembled in the sixth embodiment;

FIG. 28 is a front view of an EGR valve device including a partial cross-sectional view in a seventh embodiment;

FIG. 29 is an exploded front view of the EGR valve device including the partial cross-sectional view in the seventh embodiment;

FIG. 30 is an enlarged cross-sectional view of a second sealing member and others in another embodiment, corresponding to FIG. 9; and

FIG. 31 is an enlarged cross-sectional view of a second sealing member and others in another embodiment, corresponding to FIG. 5.

### MODE FOR CARRYING OUT THE INVENTION

A detailed description of several embodiments of an EGR valve device will now be given referring to the accompanying drawings.

### First Embodiment

A first embodiment of the EGR valve device will be described first below.

(Configuration of the EGR Valve Device)

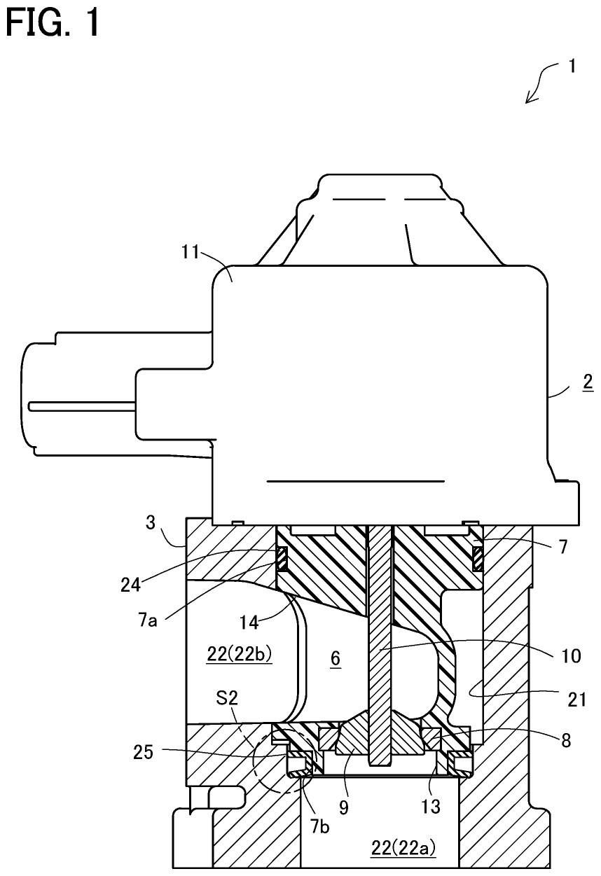

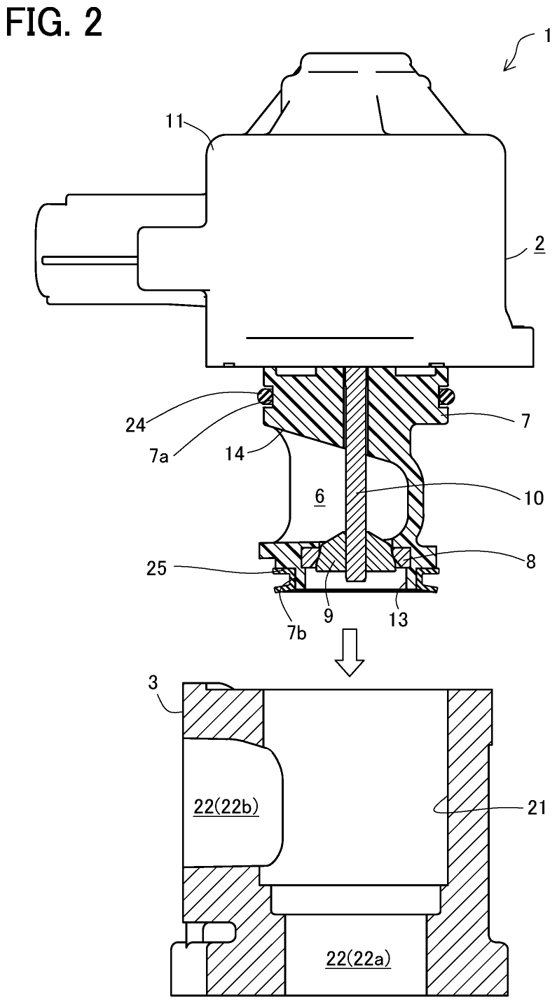

FIG. 1 is a front view of an EGR valve device 1 including a partial cross-sectional view in the present embodiment. FIG. 2 is an exploded front view of the EGR valve device 1 including a partial cross-sectional view. The EGR valve device 1 is to be placed in an EGR passage (not shown) to allow a part of exhaust gas, discharged from an engine to an exhaust passage, to flow in an intake passage to recirculate as EGR gas to the engine. The EGR valve device 1 is used to regulate a flow rate of the EGR gas in the EGR passage.

The EGR valve device 1 has a poppet valve structure as shown in FIG. 1, and mainly consists of a valve assembly 2 and a housing adaptor 3. The housing adaptor 3 corresponds to one example of a mating member in the present disclosure. The valve assembly 2 is provided with a housing 7 including a flow passage 6 for EGR gas, an annular valve seat 8 provided in the flow passage 6, a nearly-umbrella-shaped valve element 9 provided to be capable of seating on the valve seat 8 to open and close the flow passage 6, a valve shaft 10 having one end to which the valve element 9 is provided, and a driving unit 11 for driving the valve shaft 10 to reciprocate together with the valve element 9. The driving unit 11 may be constituted of a DC motor, for example. In FIG. 1, other components than the driving unit 11 are illustrated in the partial cross-sectional view. The valve seat 8 is formed separately from the housing 7 and assembled in the flow passage 6. The housing 7 is made of a resin material. The valve seat 8, the valve element 9, and the valve shaft 10 are made of a metal material. The shape of each of the valve seat 8 and the valve element 9 is one example. The EGR valve device 1 is configured to move the valve element 9 relative to the valve seat 8 to change an opening degree between the valve element 9 and the valve seat 8, thereby regulating a flow rate of EGR gas in the flow passage 6. In the present embodiment, the details of the driving unit 11 are omitted.

As shown in FIG. 1, the valve shaft 10 extends downward from the driving unit 11, and is inserted through the housing 7 and positioned in parallel to the axis of the valve seat 8. The valve element 9 is configured to seat on (contact with) and separate from the valve seat 8 in association with reciprocating movement of the valve shaft 10. In the present embodiment, the valve element 9 is placed so as to seat on the valve seat 8 from below the valve seat 8, i.e., from an upstream side of the valve seat 8.

As shown in FIGS. 1 and 2, the flow passage 6 includes an inlet 13 and an outlet 14, each provided in the housing 7. The flow passage 6 is bent, above the valve seat 8, i.e., a downstream side of the valve seat 8, in a direction perpendicular to a direction toward the inlet 13.

In the present embodiment, the housing adaptor 3 placed outside the housing 7 includes an assembly hole 21 for the housing 7 and another flow passage 22. This other flow passage 22 includes an inlet flow passage 22a and an outlet flow passage 22b. The housing 7 is assembled in the assembly hole 21 of the housing adaptor 3, forming a two-body structure valve housing. In the present embodiment, the housing 7 is made of a resin material and the housing adaptor 3 is made of a metal material, e.g., aluminum.

(Sealing Member)

In the present embodiment, a first sealing member 24 and a second sealing member 25 are placed in two places between the outer surface of the housing 7 and the inner surface of the assembly hole 21. The first sealing member 24 is placed on the outer surface of the housing 7 above the outlet 14 of the flow passage 6. The first sealing member 24 is mounted in a peripheral groove 7a formed in the outer surface of the housing 7. The second sealing member 25 is placed on the outer surface of the housing 7 below the valve seat 8. The second sealing member 25 is mounted on a small-diameter portion 7b formed in the outer surface of the housing 7. Herein, the part of the housing 7, formed with the small-diameter portion 7b, has a relatively thin wall thickness. In contrast, the part of the housing 7, formed with the peripheral groove 7a in which the first sealing member 24 is mounted, has a relatively large wall thickness, so that the stress generated by the elastic reaction force of the first sealing member 24 causes no problems.

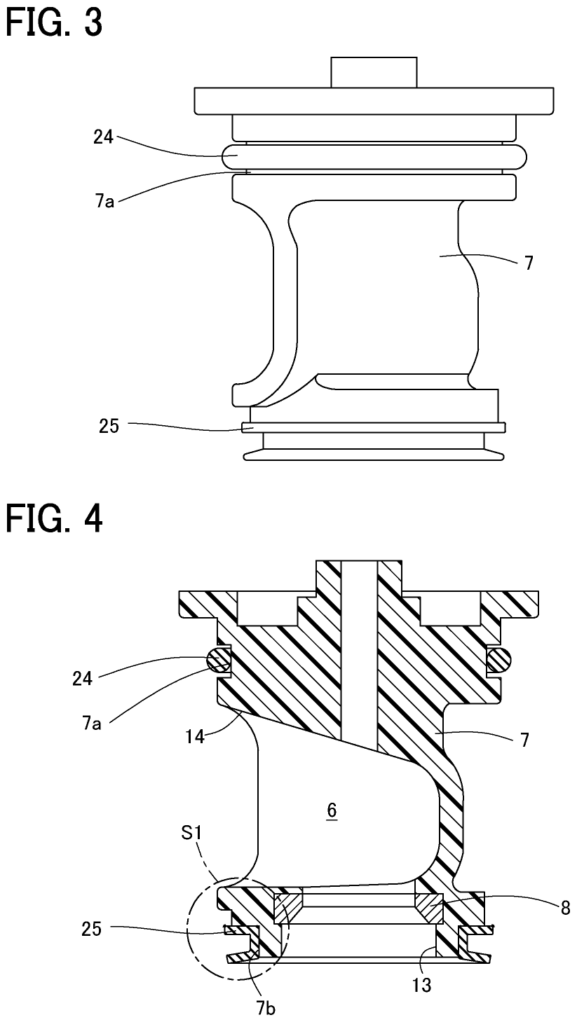

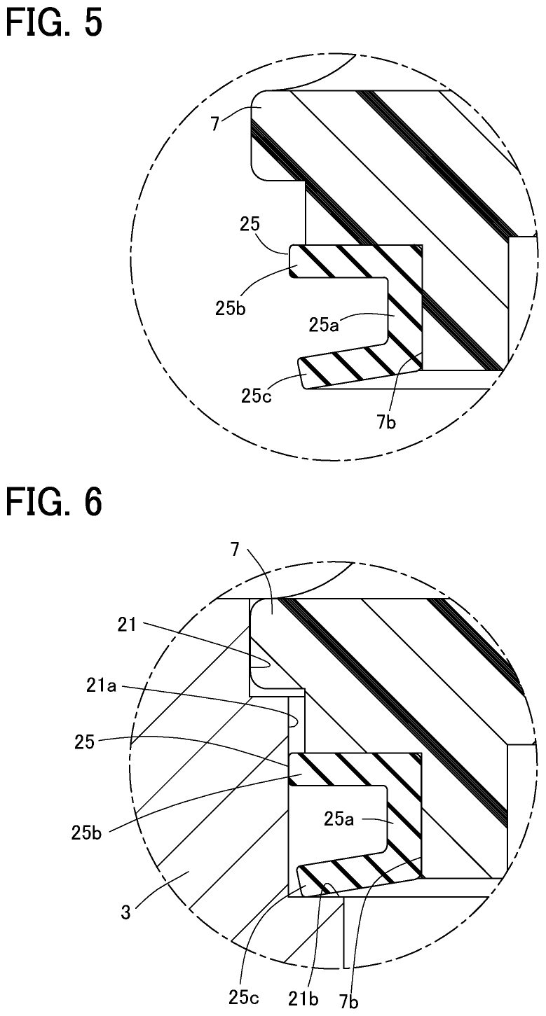

FIG. 3 is a front view of the housing 7 to which the first sealing member 24 and the second sealing member 25 are attached. FIG. 4 is a front cross-sectional view of the housing 7 to which the first sealing member 24 and the second sealing member 25 are attached. FIG. 5 is an enlarged cross-sectional view showing a part enclosed by a dot-dashed circle S1 in FIG. 4. FIG. 6 is an enlarged cross-sectional view showing a part enclosed by a dot-dashed circle S2 in FIG. 1.

In the present embodiment, the first sealing member 24 and the second sealing member 25 are each made of rubber as an elastic material in an annular shape. The first sealing member 24 is formed from an O-ring having a circular shape in cross section. On the other hand, the second sealing member 25 has an odd-shaped cross section. Specifically, as shown in FIGS. 5 and 6, the second sealing member 25 has a groove shape in cross section and is provided with an annular inner peripheral part 25a located on the inside, a rib-shaped vibration-reducing part 25b extending horizontally in a radial direction on the upper side of the inner peripheral part 25a, the vibration-reducing part 25b having a vibration-reducing function, and a rib-shaped sealing part 25c extending slightly obliquely in the radial direction on the lower side of the inner peripheral part 25a, the sealing part 25c having a sealing function. In the present embodiment, the vibration-reducing part 25b and the sealing part 25c are formed integral with each other. In the present embodiment, the first sealing member 24 and the second sealing member 25 are each attached in advance to the outer surface of the housing 7. In the present embodiment, as shown in FIGS. 5 and 6, the vibration-reducing part 25b is longer in the radial direction than the sealing part 25c.

To produce the EGR valve device 1, as shown in FIG. 2, the driving unit 11 (including the valve shaft 10 and others) produced in advance, the housing 7, the valve seat 8, the valve element 9, and the first and second sealing members 24 and 25 are assembled to each other to fabricate a valve assembly 2. In this state, the first sealing member 24 and the second sealing member 25 having been already attached to the outer surface of the housing 7. Then, the valve assembly 2 is assembled (dropped) in the assembly hole 21 of the housing adaptor 3. At that time, the flow passage 6 and the other flow passage 22 (the inlet flow passage 22a and the outlet flow passage 22b) communicate with each other between the housing 7 and the housing adaptor 3. Thus, the EGR valve device 1 shown in FIG. 1 is obtained. As shown in FIGS. 1 and 6, while the housing 7 is assembled in the assembly hole 21, the outer end of the vibration-reducing part 25b and the outer end of the sealing part 25c are separately contacted with different portions of the inner surface of the assembly hole 21. Herein, as shown in FIG. 6, the outer end of the vibration-reducing part 25b contacts the inner peripheral surface 21a of the assembly hole 21. Further, the outer end of the sealing part 25c contacts the surface of a stepped portion (a shoulder surface) 21b perpendicular to the inner peripheral surface 21a. In this contact state, the vibration-reducing part 25b performs the vibration-reducing function for the housing 7 with respect to the housing adaptor 3. The sealing part 25c performs the sealing function between the housing adaptor 3 and the housing 7.

(Operations and Effects of EGR Valve)

According to the configuration of the EGR valve device 1 in the present embodiment described above, the valve shaft 10 is driven together with the valve element 9 by the driving unit 11, thereby moving the valve element 9 relative to the valve seat 8. This changes the opening area (the opening degree) between the valve seat 8 and the valve element 9 to regulate the flow rate of EGR gas in the flow passage 6. Herein, the second sealing member 25 placed between the outer surface of the housing 7 and the inner surface of the assembly hole 21 includes the vibration-reducing part 25b having the vibration-reducing function and the sealing part 25c having the sealing function. Therefore, the second sealing member 25 contacts the inner surface of the assembly hole 21 separately through the vibration-reducing part 25b and the sealing part 25c. This configuration can reduce the stress caused by the elastic reaction force of the second sealing member 25 placed between the housing 7 and the housing adaptor 3, and thus can prevent the housing 7 made of a resin material from being damaged by the stress.

In the present embodiment, the first sealing member 24 and the second sealing member 25 are previously attached to the outer surface of the housing 7. Accordingly, when the housing 7 is assembled into the assembly hole 21, the first sealing member 24 and the second sealing member 25 are simultaneously placed between the outer surface of the housing 7 and the inner surface of the assembly hole 21. Those sealing members 24 and 25 can therefore be used with the same handling as conventional sealing members.

In the present embodiment, the second sealing member 25 is made of an elastic material (a rubber material) in an annular shape and thus can be easily molded. This enables the second sealing member 25 to be produced in the same manner as the conventional sealing members.

In the present embodiment, the vibration-reducing part 25b and the sealing part 25c of the second sealing member 25 are integral with each other, which makes it easy to handle the second sealing member 25. Accordingly, the second sealing member 25 can be used with the same handling as the conventional sealing members.

### Second Embodiment

A second embodiment of an EGR valve device including an EGR valve will be described below. In the following description, similar or identical components to those in the first embodiment are assigned the same reference signs and their details are not described, and differences from the first embodiment are focused on.

(Sealing Member)

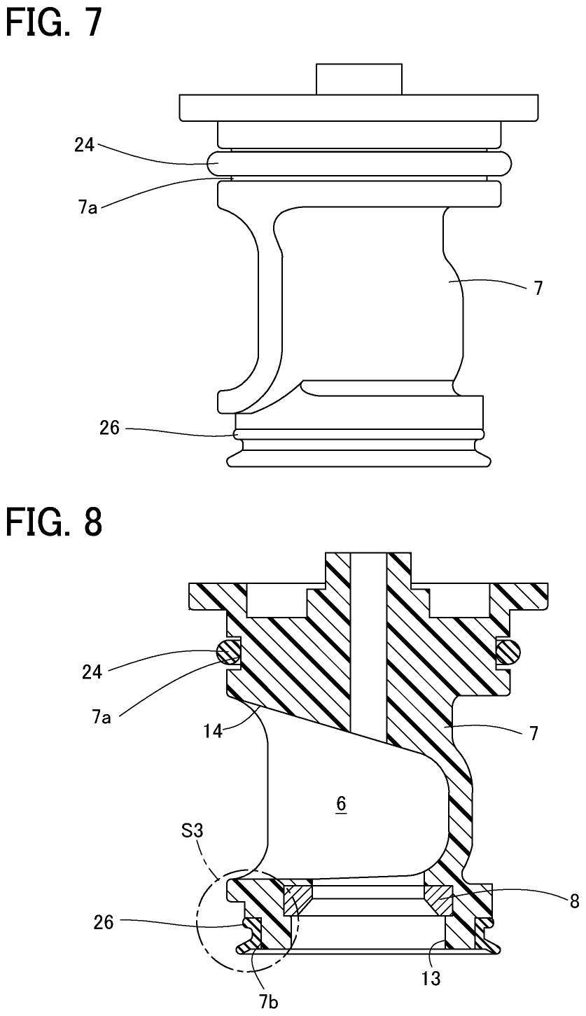

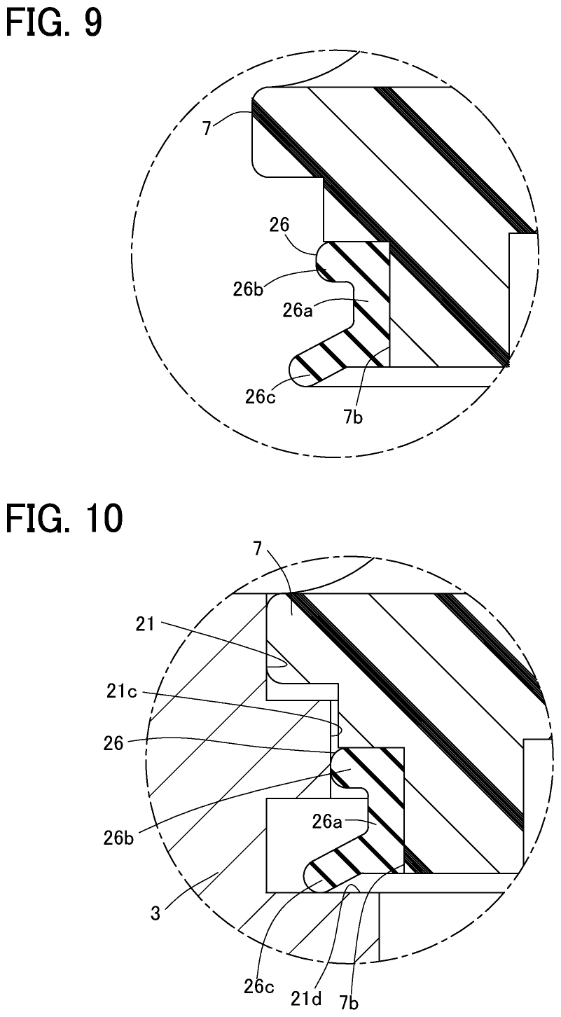

The present embodiment differs in the shape of a second sealing member 26 from the first embodiment. FIG. 7 is a front view of the housing 7, corresponding to FIG. 3. FIG. 8 is a front cross-sectional view of the housing 7, corresponding to FIG. 4. FIG. 9 is an enlarged cross-sectional view showing a part circled with a dot-chain line S3 in FIG. 8. FIG. 10 is an enlarged cross-sectional view showing a part of the EGR valve device 1, similar to FIG. 6.

In the present embodiment, as shown in FIG. 9, the second sealing member 26 has a groove shape in cross section and is provided with an annular inner peripheral part 26a located on the inside, a rib-shaped vibration-reducing part 26b extending horizontally in a radial direction on the upper side of the inner peripheral part 26a, the inner peripheral part 26b having a vibration-reducing function, and a rib-shaped sealing part 26c extending slightly obliquely in the radial direction on the lower side of the inner peripheral part 26a, the sealing part 26c having a sealing function. This second sealing member 26 also has the groove-shaped cross section as in the first embodiment, but differs from the first embodiment in that the vibration-reducing part 26b is shorter than the sealing part 26c in a radial direction in FIGS. 9 and 10. As shown in FIG. 10, while the housing 7 is assembled in the assembly hole 21, the outer end of the vibration-reducing part 26b and the outer end of the sealing part 26c are separately contacted with different portions of the inner surface of the assembly hole 21. Herein, as shown in FIG. 10, the outer end of the vibration-reducing part 26b contacts the inner peripheral surface 21c of the assembly hole 21. Further, the outer end of the sealing part 26c contacts a shoulder surface 21d perpendicular to the inner peripheral surface 21c. In this contact state, the vibration-reducing part 26b performs the vibration-reducing function for the housing 7 with respect to the housing adaptor 3. The sealing part 26c performs the sealing function between the housing adaptor 3 and the housing 7.

(Operations of Effects of the EGR Valve)

According to the configuration of the EGR valve device 1 in the present embodiment described above, the same operations and effects as in the first embodiment can be achieved. In the present embodiment, furthermore, the vibration-reducing part 26b is shorter in the radial direction than the sealing part 26c, so that the housing 7 can be inserted in the assembly hole 21 with less resistance.

### Third Embodiment

A third embodiment of an EGR valve device including an EGR valve will be described below.

(Sealing Member)

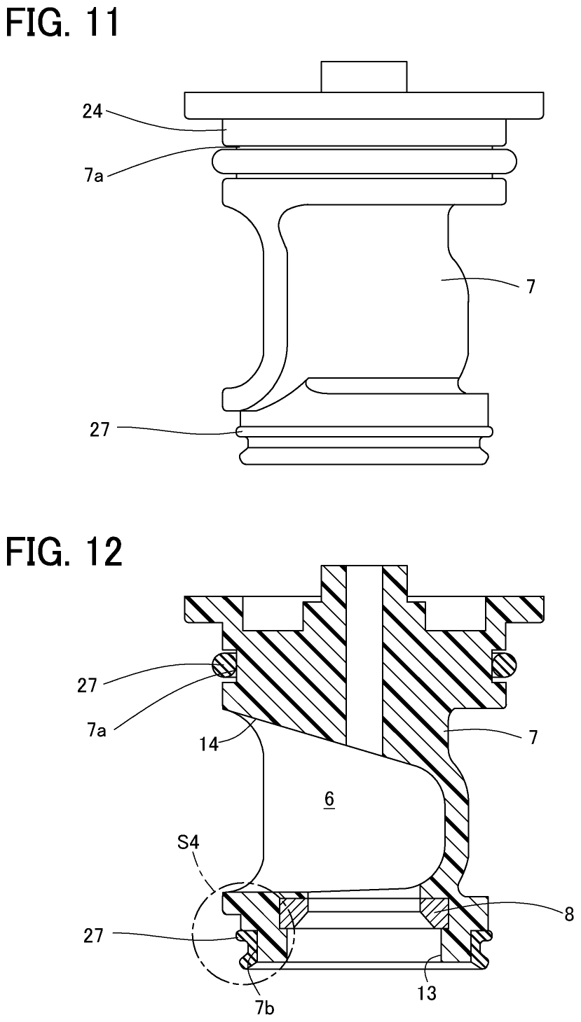

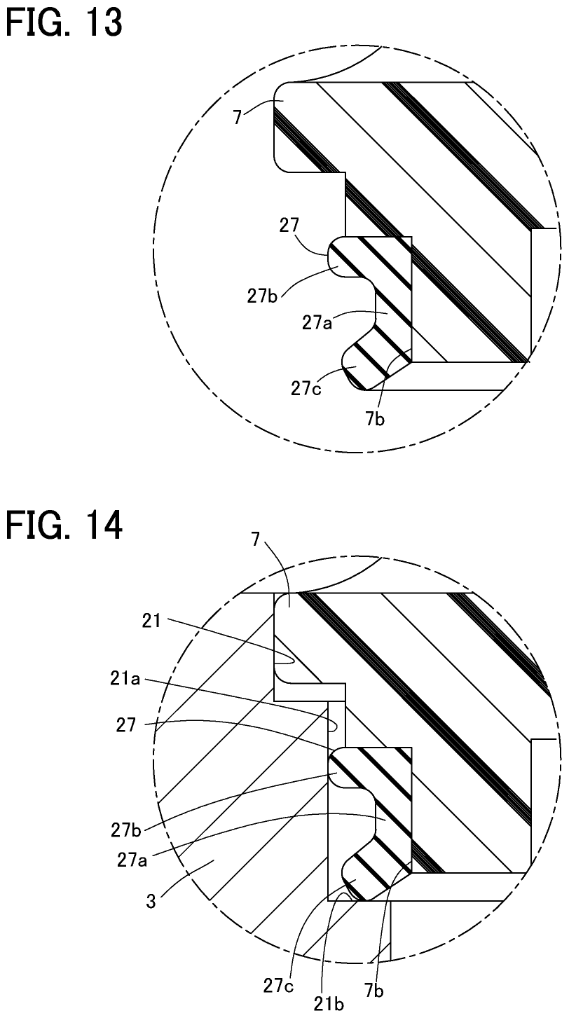

The present embodiment differs from each of the foregoing embodiments in the shape of a second sealing member 27. FIG. 11 is a front view of the housing 7, corresponding to FIG. 3. FIG. 12 is a front cross-sectional view of the housing 7, corresponding to FIG. 4. FIG. 13 is an enlarged cross-sectional view showing a part enclosed by a dot-dashed circle S4 in FIG. 12. FIG. 14 is an enlarged cross-sectional view showing a part of the EGR valve device 1, corresponding to FIG. 6.

In the present embodiment, as shown in FIG. 13, the second sealing member 27 has a groove shape in cross section and is provided with an annular inner peripheral part 27a located on the inside, a rib-shaped vibration-reducing part 27b extending horizontally in a radial direction on the upper side of the inner peripheral part 27a, the vibration-reducing part 27b having a vibration-reducing function, and a rib-shaped sealing part 27c extending slightly obliquely in the radial direction on the lower side of the inner peripheral part 27a, the sealing part 27c having a sealing function. This second sealing member 27 also has the groove-shaped cross section as in the first embodiment, but differs from the first embodiment in that both the vibration-reducing part 27b and the sealing part 27c are shorter in the radial direction in FIGS. 13 and 14 than the vibration-reducing part 25b and the sealing part 25c of the second sealing member 25 in the first embodiment. As shown in FIG. 14, while the housing 7 is assembled in the assembly hole 21, the outer end of the vibration-reducing part 27b and the outer end of the sealing part 27c are separately contacted with different portions of the inner surface of the assembly hole 21. Herein, as shown in FIG. 14, the outer end of the vibration-reducing part 27b contacts the inner peripheral surface 21a of the assembly hole 21. Further, the outer end of the sealing part 27c contacts with the shoulder surface 21b perpendicular to the inner peripheral surface 21a. In this contact state, the vibration-reducing part 27b performs the vibration-reducing function for the housing 7 with respect to the housing adaptor 3. The sealing part 27c performs the sealing function between the housing adaptor 3 and the housing 7.

(Operations of Effects of the EGR Valve)

According to the configuration of the EGR valve device 1 in the present embodiment described above, the same operations and effects as in the first embodiment can be achieved. In the present embodiment, furthermore, both the vibration-reducing part 27b and the sealing part 27c of the second sealing member 27 are radially shorter than the vibration-reducing part 25b and the sealing part 25c of the second sealing member 25 in the first embodiment, so that the housing 7 can be inserted in the assembly hole 21 with even less resistance.

### Fourth Embodiment

A fourth embodiment of an EGR valve device including an EGR valve will be described below.

(Sealing Member)

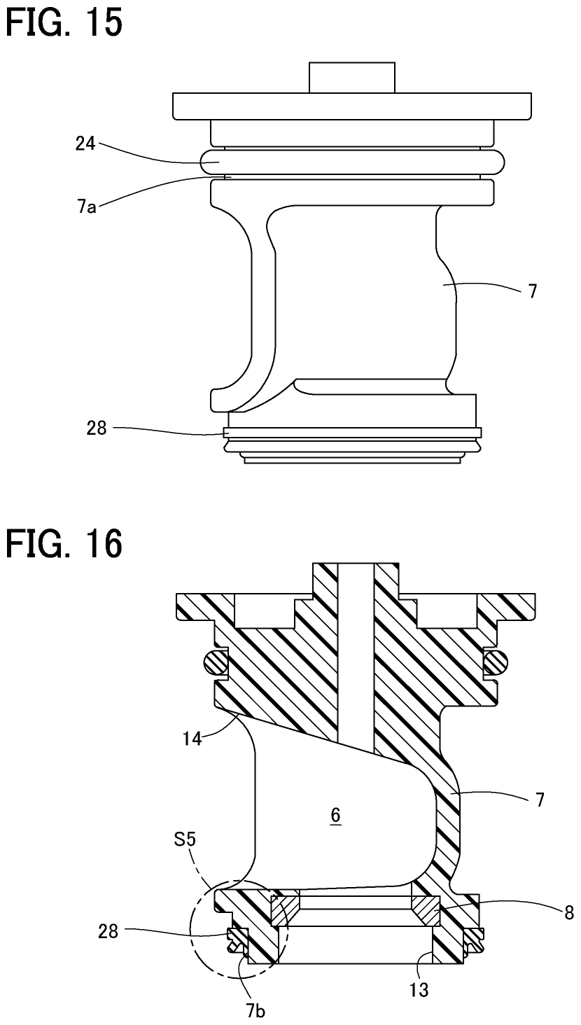

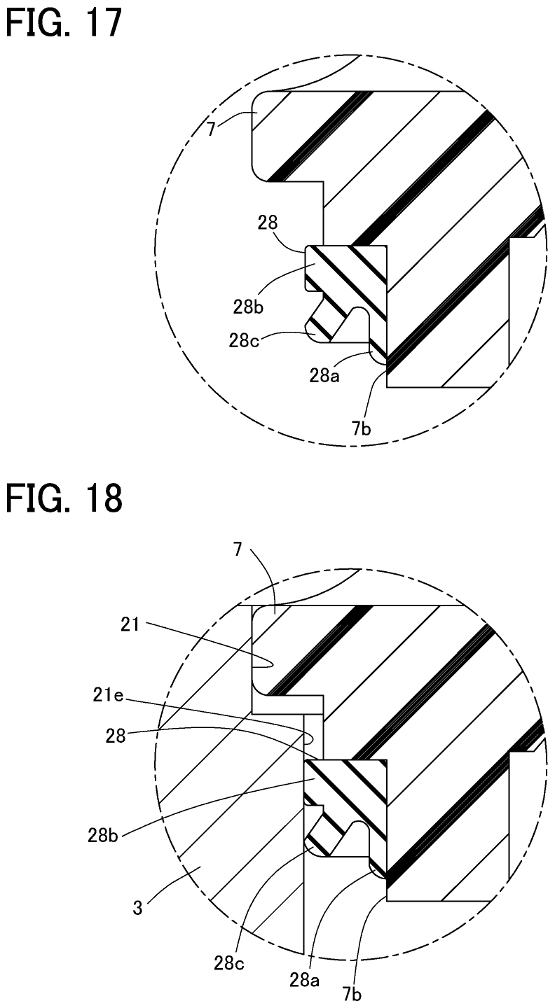

The present embodiment differs in the shape of a second sealing member 28 from each of the foregoing embodiments. FIG. 15 is a front view of the housing 7, corresponding to FIG. 3. FIG. 16 is a front cross-sectional view of the housing 7, corresponding to FIG. 4. FIG. 17 is an enlarged cross-sectional view showing a part enclosed by a dot-dashed circle S5 in FIG. 16. FIG. 18 is an enlarged cross-sectional view showing a part of the EGR valve device 1, corresponding to FIG. 6.

In the present embodiment, as shown in FIG. 17, the second sealing member 28 has a nearly arrow-head shape in cross section and is provided with an annular inner peripheral part 28a located on the inside, a rib-shaped vibration-reducing part 28b extending horizontally in a radial direction on the upper side of the inner peripheral part 28a, the inner peripheral part 26b having a vibration-reducing function, and a rib-shaped sealing part 28c extending slightly obliquely in a radial direction between the inner peripheral part 28a and the vibration-reducing part 28b, the sealing part 28c having a sealing function. This second sealing member 28 also has the groove-shaped cross section different from each of the foregoing embodiments and both the vibration-reducing part 28b and the sealing part 28c extend with the same length in a radial direction in FIGS. 17 and 18. As shown in FIG. 18, while the housing 7 is assembled in the assembly hole 21, the outer end of the vibration-reducing part 28b and the outer end of the sealing part 28c are separately contacted with different portions of the inner surface of the assembly hole 21. Herein, as shown in FIG. 18, the outer end of the vibration-reducing part 28b contacts an inner peripheral surface 21e of the assembly hole 21. Further, the outer end of the sealing part 28c contacts the same inner peripheral surface 21e below the vibration-reducing part 28b. In this contact state, the vibration-reducing part 28b performs the vibration-reducing function for the housing 7 with respect to the housing adaptor 3. The sealing part 28c performs the sealing function between the housing adaptor 3 and the housing 7.

(Operations of Effects of the EGR Valve)

According to the configuration of the EGR valve device 1 in the present embodiment described above, the same operations and effects as in the first embodiment can be achieved.

### Fifth Embodiment

A fifth embodiment of an EGR valve device including an EGR valve will be described below.

(Sealing Member)

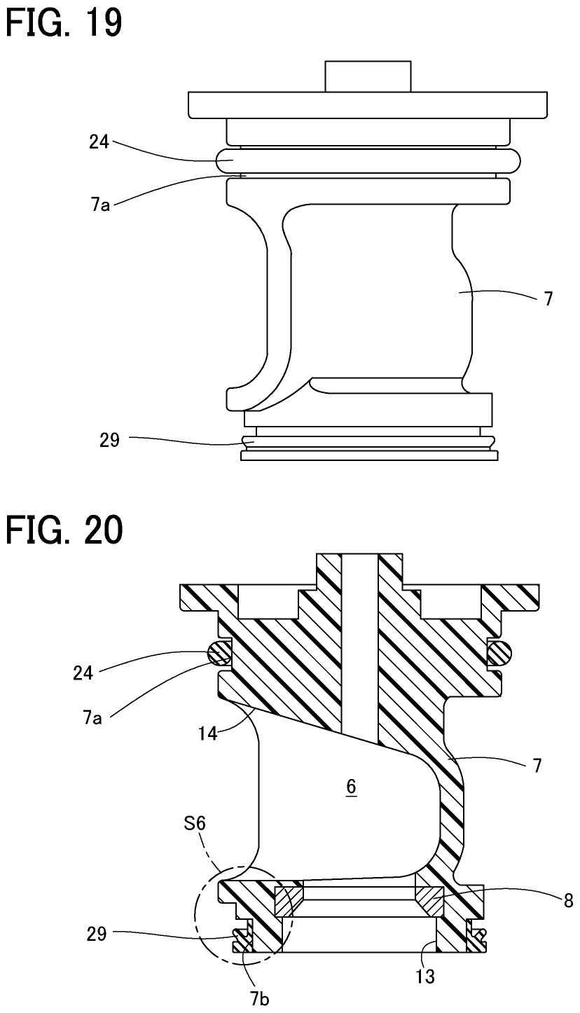

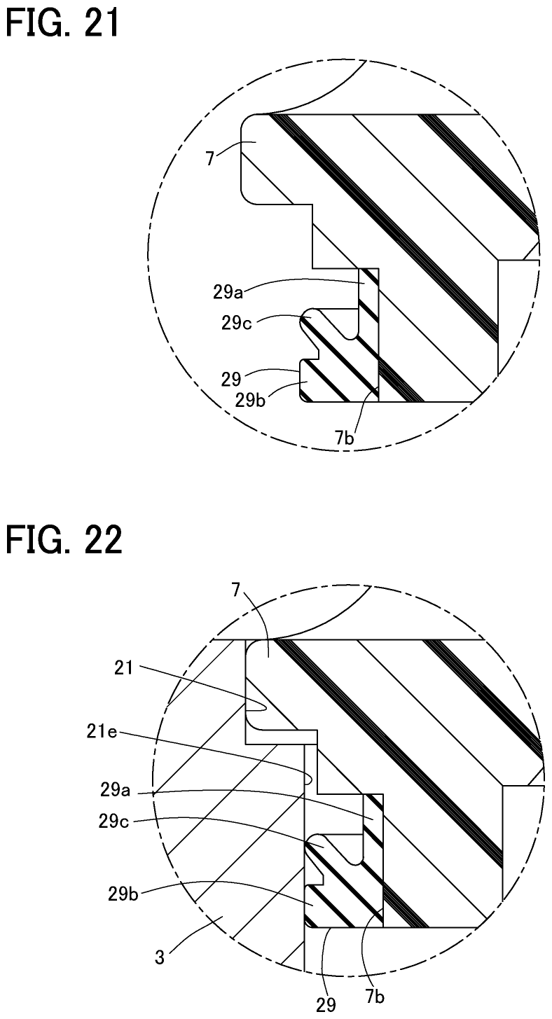

The present embodiment differs in the shape of a second sealing member 29 from each of the foregoing embodiments. FIG. 19 is a front view of the housing 7, corresponding to FIG. 3. FIG. 20 is a front cross-sectional view of the housing 7, similar to FIG. 4. FIG. 21 is an enlarged cross-sectional view showing a part enclosed by a dot-dashed circle S6 in FIG. 20. FIG. 22 is an enlarged cross-sectional view showing a part of the EGR valve device 1, corresponding to FIG. 6.

In the present embodiment, as shown in FIG. 21, the second sealing member 29 has a nearly arrow-head shape in cross section and is provided with an annular inner peripheral part 29a located on the inside, a rib-shaped vibration-reducing part 29b extending horizontally in a radial direction below the inner peripheral part 29a, the vibration-reducing part 29b having a vibration-reducing function, and a rib-shaped sealing part 29c extending slightly obliquely in a radial direction between the inner peripheral part 29a and the vibration-reducing part 29b, the sealing part 29c having a sealing function. This second sealing member 29 also has the groove-shaped cross section different from each of the foregoing embodiments and both the vibration-reducing part 29b and the sealing part 29c extend with the same length in a radial direction in FIGS. 21 and 22. As shown in FIG. 22, while the housing 7 is assembled in the assembly hole 21, the outer end of the sealing part 29c and the outer end of the vibration-reducing part 29b are separately contacted with different portions of the inner surface of the assembly hole 21. Herein, as shown in FIG. 22, the outer end of the sealing part 29c contacts an inner peripheral surface 21e of the assembly hole 21. Further, the outer end of the sealing part 29b contacts the same inner peripheral surface 21e below the vibration-reducing part 29c. In this contact state, the sealing part 29c performs the sealing function for the housing 7 with respect to the housing adaptor 3. The vibration-reducing part 29b performs the vibration-reducing function between the housing 7 and the housing adaptor 3.

(Operations of Effects of the EGR Valve)

According to the configuration of the EGR valve device 1 in the present embodiment described above, the same operations and effects as in the first embodiment can be achieved.

### Sixth Embodiment

A sixth embodiment of an EGR valve device including an EGR valve will be described below.

(Sealing Member)

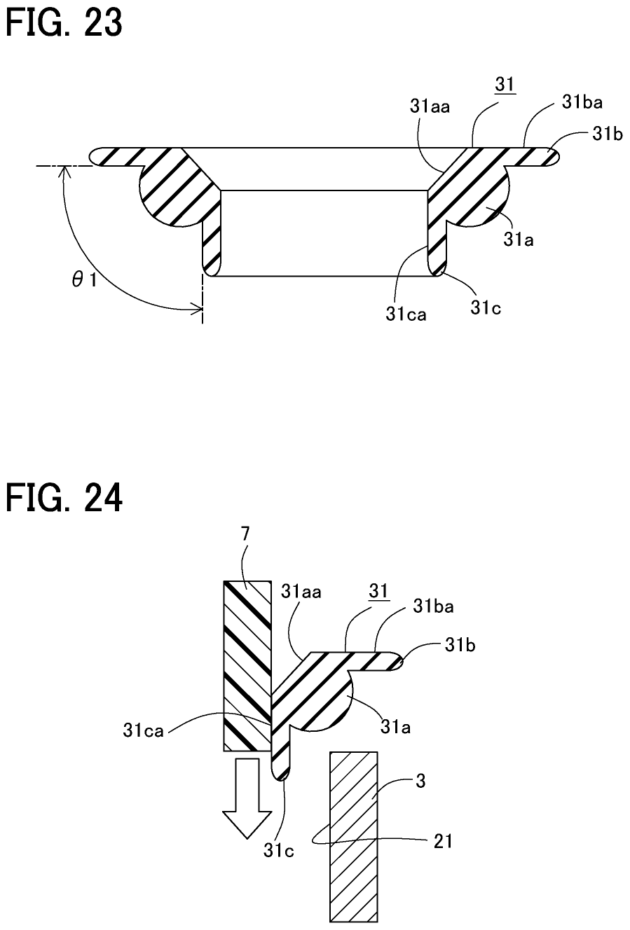

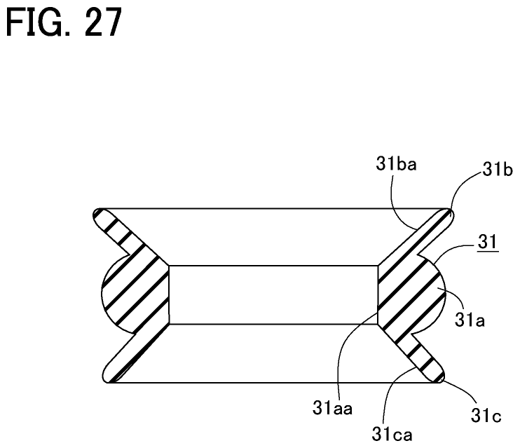

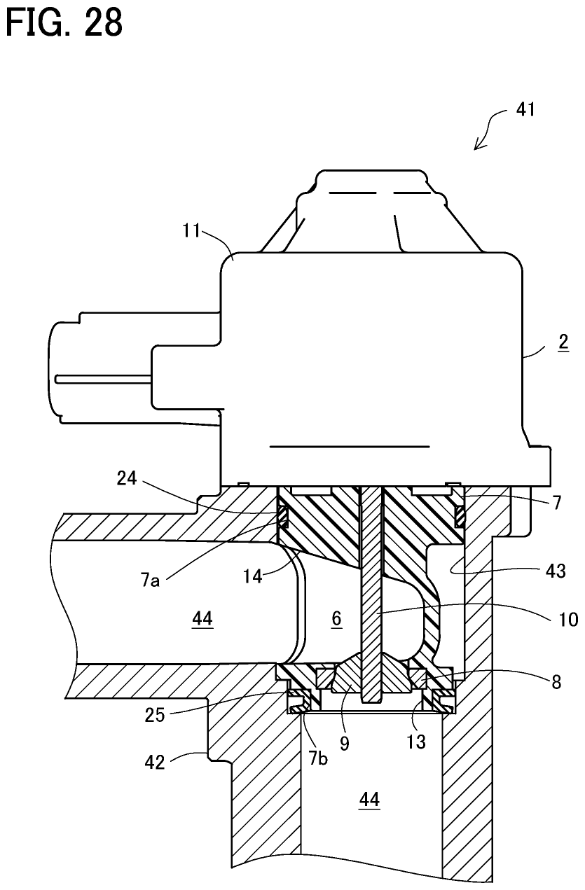

The present embodiment differs in the shape of a sealing member 31 from the second sealing members 25 to 29 in the foregoing embodiments. FIG. 23 is a cross-sectional view showing the sealing member 31, taken along the axial direction, before being assembled between the housing 7 and the housing adaptor 3. FIGS. 24 to 26 are cross-sectional views conceptually showing each step in the process of assembling the housing 7 with the sealing member 31 attached thereto into the assembly hole 21 of the housing adaptor 3. FIG. 27 is a cross-sectional view showing the sealing member 31, taken along the axial direction, after being assembled between the housing 7 and the housing adaptor 3.

In the present embodiment, the sealing member 31 is made of a rubber material as an elastic material in an annular shape. This sealing member 31 has an odd-shaped cross section. Specifically, as shown in FIG. 23, the sealing member 31 has a nearly hat-like shape in cross section and is provided with a vibration-reducing part 31a protruding in a dome-like shape at the center and having a vibration-reducing function, and a first sealing part 31b and a second sealing part 31c respectively extending slightly obliquely in a rib shape on the upper side and the lower side of the vibration-reducing part 31a. An open angle θ1 between the first sealing part 31b and the second sealing part 31c is approximately 90°. The inner periphery of the sealing member 31 is configured such that an inner surface 31aa of the vibration-reducing part 31a between the first sealing part 31b and the second sealing part 31c, is flat and an inner surface 31ba of the first sealing part 31b and an inner surface 31ca of the second sealing part 31c intersect with the inner surface 31aa. In the present embodiment, the vibration-reducing part 31a and both the sealing parts 31b and 31c are formed integrally. Accordingly, when the housing 7 is assembled into the assembly hole 21, as shown in FIGS. 23 to 27, the sealing member 31 is configured so that the vibration-reducing part 31a is placed in a posture to perform the vibration-reducing function and the first sealing part 31b and the second sealing part 31c are each placed in a posture to perform the sealing function.

Herein, the process of assembling the housing 7 into the assembly hole 21 of the housing adaptor 3 will be described in sequence below. FIG. 24 is a cross-sectional view conceptually showing the state of the housing 7 before being assembled in the assembly hole 21. In this state, the sealing member 31 is attached to the housing 7 so that the inner surface 31ca of the second sealing part 31c engages with the outer surface of the housing 7.

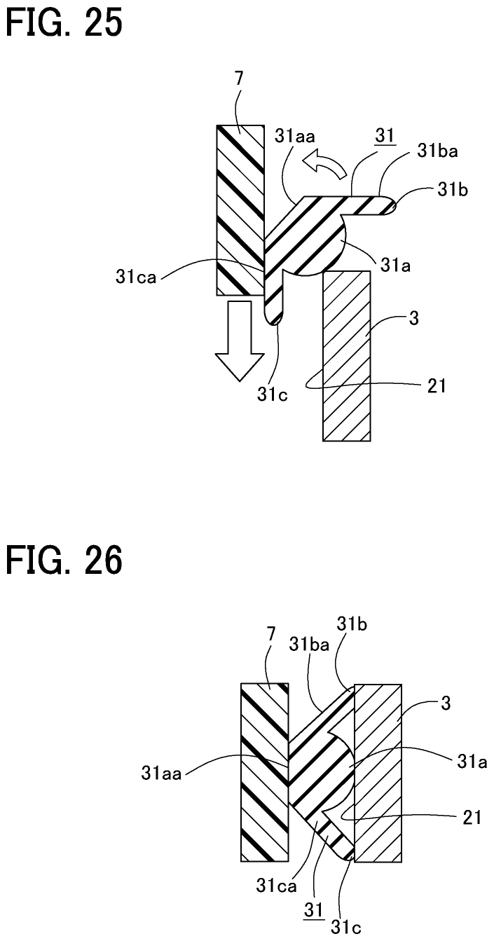

When the housing 7 is moved in a direction indicated by an arrow from the state before assembling shown in FIG. 24, the vibration-reducing part 31a comes to engage with an entrance of the assembly hole 21 as shown FIG. 25. In this state, the housing 7 is further moved in an assembling direction, thereby pushing the sealing member 31 to rotate, thus causing the inner surface 31aa of the vibration-reducing part 31a to engage with the outer surface of the housing 7.

As the housing 7 is further moved in the assembling direction indicated by the arrow from the engaged state shown in FIG. 25, the outer end of the vibration-reducing part 31a comes into contact with the inner surface of the assembly hole 21 and further the outer end of the first sealing part 31b and the outer end of the second sealing part 31c turn into respective states that engage with the same inner surface of the assembly hole 21, above and below the vibration-reducing part 31a, as shown in FIG. 26. In this contact state, the vibration-reducing part 31a performs the vibration-reducing function for the housing 7 with respect to the housing adaptor 3. Furthermore, the first and second sealing parts 31b and 31c each perform the sealing function between the housing adaptor 3 and the housing 7.

(Operations of Effects of the EGR Valve)

According to the configuration of the EGR valve device 1 in the present embodiment described above, the same operations and effects as in the first embodiment can be achieved. In the present embodiment, additionally, simply assembling the housing 7 in the assembly hole 21 enables the vibration-reducing part 31a and the two sealing parts 31b and 31c of the sealing member 31 to be placed in the postures for performing respective functions. This configuration can prevent the sealing member 31 from curling up due to the assembling of the housing 7 into the assembly hole 21 and also ensure the sealing member 31 to perform the vibration-reducing function and the sealing function.

In the present embodiment, the sealing member 31 including two sealing parts 31b and 31c can achieve the sealing function improved accordingly.

### Seventh Embodiment

A seventh embodiment of an EGR valve device will be described below.

(Configurations of the EGR Valve Device)

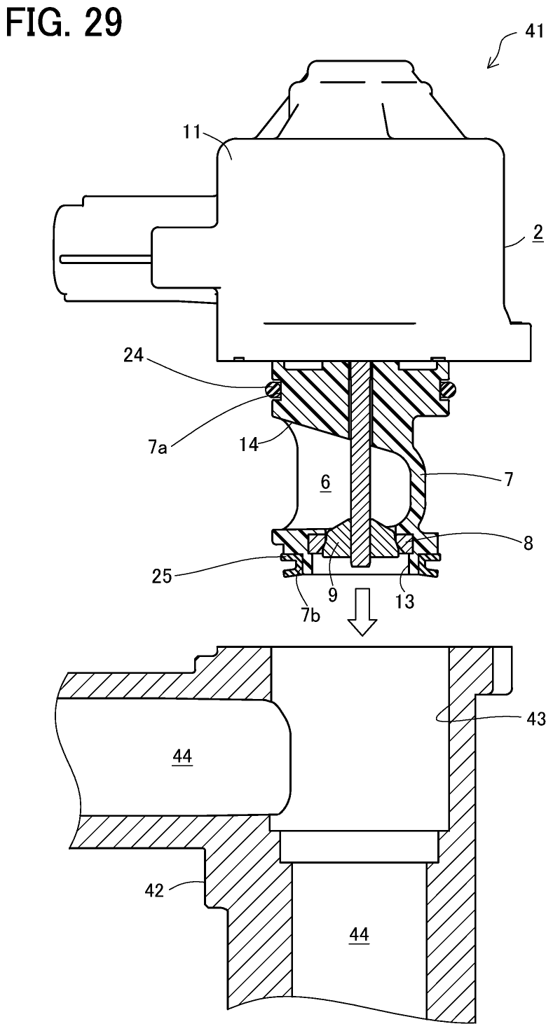

FIG. 28 is a front view of an EGR valve device 41 including a partial cross-sectional view in the present embodiment. FIG. 29 is an exploded front view of the EGR valve device 41 including the partial cross-sectional view. As shown in FIG. 28, the EGR valve device 41 is provided with the valve assembly 2 and an EGR passage 42 which is a mating member in which the housing 7 of the valve assembly 2 is assembled. This valve assembly 2 is identical in configuration to that in the first embodiment. The EGR passage 42 includes an assembly hole 43 and other flow passages 44 for flowing EGR gas.

In this EGR valve device 41, as shown in FIG. 29, the housing 7 of the valve assembly 2 is assembled (dropped) in the assembly hole 43 of the EGR passage 42 and thus assembled in the EGR passage 42. In this assembled state, the inlet 13 and the outlet 14 of the housing 7 communicate with the other flow passages 44.

(Sealing Member)

In the present embodiment, the valve assembly 2 is identical in configuration to that in the first embodiment and therefore the first sealing member 24 and the second sealing member 25 are identical in configuration to those in the first embodiment.

(Operations of Effects of the EGR Valve Device)

According to the configuration of the EGR valve device 41 in the present embodiment described above, the same operations and effects as in the first embodiment can be achieved. In the present embodiment, additionally, assembling of the housing 7 of the valve assembly 2 into the assembly hole 43 of the EGR passage 42 (the mating member) enables the valve assembly 2 to be installed in the EGR passage 42. Thus, the valve assembly 2 does not require any additional configuration for installation and thus can achieve space-saving just by that much. Further, this valve assembly 2 may be commonalized to allow assembling in any assembly hole of various mating members. This space-saving of the valve assembly 2 can accordingly enlarge the flow passage 6 and also improve the general versatility of the valve assembly 2 for various mating members.

This disclosure is not limited to each of the aforementioned embodiments, and may be implemented with appropriate changes to some of the configurations without departing from the essential characteristics of the disclosure.

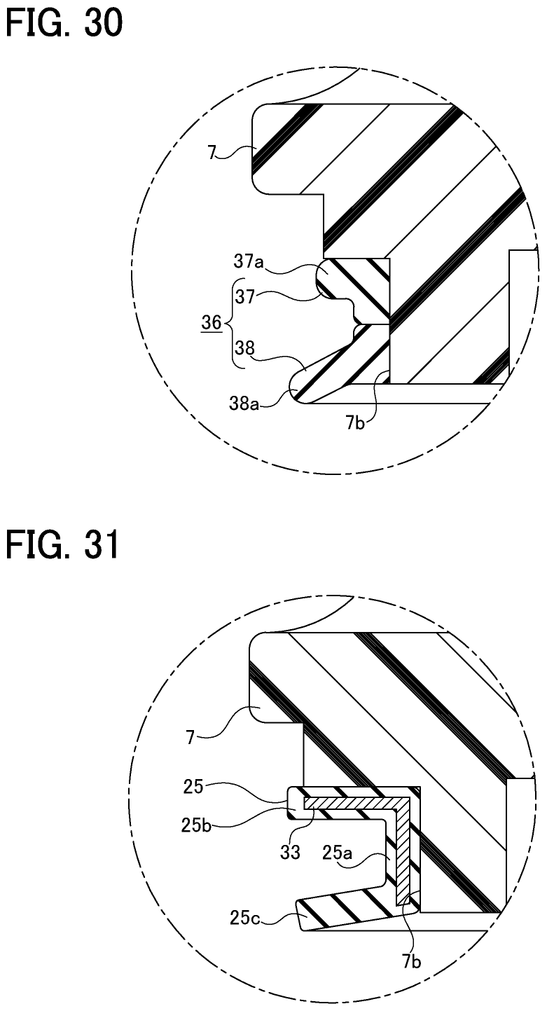

(1) In each of the foregoing embodiments, in the second sealing members 25 to 29 and the sealing member 31, the vibration-reducing parts 25b, 26b, 27b, 28b, 29b, and 31a are formed correspondingly integral with the sealing parts 25c, 26c, 27c, 28c, 29c, or 31b and 31c. As an alternative, for example, as shown in FIG. 30, a sealing member 36 may be composed of separated parts, i.e., a first sealing member segment 37 including a vibration-reducing part 37a and a second sealing member segment 38 including a sealing part 38a. In this case, the first sealing member segment 37 with the vibration-reducing part 37a and the second sealing member segment 38 with the sealing part 38a are separately formed. This configuration can increase the degree of freedom in molding the vibration-reducing part 37a and the sealing part 38a. FIG. 30 is an enlarged cross-sectional view of the sealing member 36 and others, corresponding to FIG. 9.

(2) In each of the foregoing embodiments, for example, the second sealing member 25 is made of only a rubber material as an elastic material. As an alternative, for example, a metal member 33 (e.g., iron or SUS, etc.) for reinforcement may be insert-molded in an elastic material (a rubber material) to form the second sealing member 25. In this case, the shape and characteristics of the second sealing member 25 made of only the elastic material (the rubber material) can be reinforced by the metal member 33. Thus, the second sealing member 25 can have an enhanced holding ability with respect to the housing 7. FIG. 31 is an enlarged cross-sectional view of the second sealing member 25 and others, corresponding to FIG. 5.

(3) In the foregoing first to fifth, and seventh embodiments, the first sealing member 24 is constituted of a conventional O-ring. As an alternative, the first sealing member may be configured similar to the second sealing members 25 to 29 or the sealing member 31.

(4) The position of the sealing member provided with the vibration-reducing part and the sealing part in the housing is not limited to those in the first to fifth and seventh embodiments and may be appropriately changed.

(5) In the foregoing first to fifth embodiments, the housing 7 is made of a resin material and the housing adaptor 3 is made of a metal material, e.g., aluminum. As an alternative, the housing and the housing adaptor may be both made of a metal material or made of a resin material.

(6) In the foregoing seventh embodiment, the valve assembly 2 is configured to be assembled to the EGR passage 42 which is the mating member. However, the mating member is not limited to the EGR passage, and an EGR cooler, an EGR gas distributor, and others may be assumed as the mating member.

(7) In the foregoing first to fifth, and seventh embodiments, the first sealing member 24 and the second sealing member 25 to 29 are attached in advance to the outer surface of the housing 7, and the housing 7 is assembled in the assembly hole 21 of the housing adaptor 3 as the mating member or in the assembly hole 43 of the EGR passage 42 as the mating member. An alternative may be configured such that the first sealing member and the second sealing member are not attached in advance to the outer surface of the housing, and instead the sealing member is attached in advance to the inner surface of the assembly hole of the housing adaptor or the EGR passage and further the housing is assembled in the relevant assembly hole.

### INDUSTRIAL APPLICABILITY

The present disclosure can be utilized for an EGR device mounted in a gasoline engine or a diesel engine.

### REFERENCE SIGNS LIST

1 EGR valve device
2 Valve assembly
3 Housing adaptor (Mating member)
6 Flow passage
7 Housing
8 Valve seat
9 Valve element
10 Valve shaft
13 Inlet
14 Outlet
21 Assembly hole
22 Other flow passage
24 First sealing member
25 Second sealing member
25b Vibration-reducing part
25c Sealing part
26 Second sealing member
26b Vibration-reducing part
26c Sealing part
27 Second sealing member
27b Vibration-reducing part
27c Sealing part
28 Second sealing member
28b Vibration-reducing part
28c Sealing part
29 Second sealing member
29b Vibration-reducing part
29c Sealing part
31 Sealing member
31a Vibration-reducing part
31b First sealing part
31c Second sealing part
33 Metal member
36 Sealing member
37a Vibration-reducing part
38a Sealing part
41 EGR valve device
42 EGR passage (Mating member)
43 Assembly hole
44 Other flow passage

1. An EGR valve device comprising:
a housing including a flow passage for EGR gas, the flow passage including an inlet and an outlet provided in the housing;
a valve element to open and close the flow passage;
a valve shaft to which the valve element is provided; and
a mating member in which the housing is assembled, the mating member including:
an assembly hole for the housing; and another flow passage,
wherein when the housing is assembled in the assembly hole of the mating member, the inlet and the outlet of the flow passage communicate with the other flow passage, and a sealing member is provided in at least one place between an outer surface of the housing and an inner surface of the assembly hole, and
wherein the sealing member is made of an elastic material and includes a vibration-reducing part having a vibration-reducing function and a sealing part having a sealing function.

2. The EGR valve device according to claim 1, wherein the sealing member is attached in advance in the at least one place on the outer surface of the housing.

3. The EGR valve device according to claim 1, wherein the sealing member is made of an elastic material in an annular shape.

4. The EGR valve device according to claim 3, wherein the sealing member is provided with a metal member for reinforcement, the metal member being placed inside the elastic material in the annular shape.

5. The EGR valve device according to claim 1, wherein the sealing member is configured such that the vibration-reducing part and the sealing part are formed separately and arranged adjacent to each other.

6. The EGR valve device according to claim 1, wherein the sealing member is configured such that the vibration-reducing part and the sealing part are formed integral with each other.

7. The EGR valve device according to claim 1, wherein the sealing member is configured such that the vibration-reducing part is placed in a posture to perform the vibration-reducing function and the sealing part is placed in a posture to perform the sealing function when the housing is assembled in the assembly hole.
